(19) United States
(12) Patent Application Publication
(10) Pub. No.: US 2005/0218774 A1
(43) Pub. Date: Oct. 6, 2005

(54) Incandescent electric lamp and socket assembly

(76) Inventor: Ramachandra Shrikrishna Bhagwat, Maharashtra (IN)

Correspondence Address: NIXON & VANDERHYE, PC, 901 NORTH GLEBE ROAD, 11TH FLOOR, ARLINGTON, VA, 22203, US

(21) Appl. No.: 10/511,424

(22) PCT Filed: Apr. 26, 2002
(86) PCT No.: PCT/IN02/00113

§ 371 Date: May 12, 2005

(51) Int. Cl. H01J 5/48; H01J 5/50

(52) U.S. Cl. 313/318.01; 313/318.03

(57) ABSTRACT

An incandescent lamp assembly is characterised by adapter (5) and adjustment collar means. The assembly essentially comprises a single ended capsule (1) having a press seal (3) thereof. One or more filaments (2) are located inside the capsule (1) and current connection leads (15) extend from the press seal (3). The adapter means (5) has an elevated or stepped up portion (8″) having a slit (6′) through said elevated or stepped up portion (8″) thereof for receiving the press seal portion (3) of said capsule (1). In addition, an adjustment collar (10) has a flat surface and downwardly extending sidewalls (11), said adapter means (5) being weldably mounted on said adjustment collar (10), said adjustment collar (10) having an opening (9″) for receiving at least a part of said press seal portion (3) and current connection leads (15), while a socket means (14) is closed at one end with an insulated material in which the said electrical connection leads (15) are embedded, the open upper potion of the socket (14) means receiving said adjustment collar (10) in a snug yet adjustable manner; one or more weld means (16) for weldably connecting said socket means (14) to said adjustment collar (10) and a pair of connection prongs (12) extending outwardly and downwardly from said insulating material.

### FIELD OF THE INVENTION

The present invention relates to lamps, particularly halogen incandescent lamps. More particularly, the present invention relates to novel incandescent lamp and socket assembly, which is simple to assemble and easy to align with respect to the reflector with which it will be generally used. The present invention also relates to a method of assembling the incandescent lamp to the socket and a stepped ring at a predetermined focus with respect to a reference plane, formed by a plurality of projections on the stepped ring. The lamp-socket assembly of the present invention is particularly suitable for use in automotive headlights where the position of the filament of the lamp with respect to the focus of the reflector is of utmost importance for the required light distribution emanating from the headlight beam. Apart from the fact that the lamp must be accurately aligned with respect to the focus of the reflector, it s very important that such alignment is retained in spite of the shock and vibration of the vehicle which may be transferred to the lamp. The present invention ideally satisfied these requirements in an improved and hitherto unknown manner.

### BACKGROUND OF THE INVENTION

Lamps, particularly, halogen incandescent lamps are well known in the art. Most known lamps employ glass capsules with at least a filament having lead wires for electrical connections to the filament. The glass capsule may have one end flattened or pinched into a press seal. The glass capsule may be made of high temperature resistant glass such as quartz glass. While, the lamps with a single filament are known two filament lamps for projection of “high beam” and “low beam” are particularly common.

For example, U.S. Pat. No. 4,412,273 granted to Helbig et al. Describes a two filament halogen incandescent lamp. The lamp of this patent is characterised by a socket comprising a cylindrical positioning sleeve, which is fitted into and a cylindrical socket sleeve. After ensuring that the lamp is correctly positioned, so that the filaments will emit light in a predetermined pattern with respect to the base, the two sleeves are welded together. The diameter of the adjustment sleeve and socket sleeve are so well matched that the former is securely seated in the latter, yet adjustable therewith and a plastic element located therein prior to the welding. The adjustment sleeve has a central opening to receive the single ended press seal of the lamp capsule with necessary electrical offset with respect to the axis of the socket. The plastic portion includes a groove in which a sealing ring made of silicone rubber is placed. The entire assembly is fitted with a reflector with the sealing ring ensuring a moisture tight seal.

The lamp of the above-disclosed US patent, however, suffered from certain inherent disadvantages. The base core structure of this lamp assembly was found to be particularly complex and also presented certain manufacturing difficulties.

British Patent No. 2 093 632 in attempt to simplify the above construction describes lamp assembly characterised by a two part base in which the base core is made of ceramic. The ceramic core is coupled to the base sleeve by riveting. In order to ensure that some play is left, the structure requires additional riveting and riveting part. The focus of the emanating beam and its optical quality is largely dependent on the manner in which the lamp is secured to its base. The assembly of this patent demands that as little play as possible is used in order to ensure that the lamp does not jump out of alignment with respect to the focal point of the reflector. The main disadvantage of the lamp of this patent has been that the base core is made of ceramic and therefore, that much difficult to manufacture to close tolerances. Therefore, a rivet connection, which is tight and meets tolerance requirements, is difficult to make.

U.S. Pat. No. 5,010,272 of Eckhardt et al discloses a slightly more compact structure where the base is again a two part structure comprising of a base core and a base sleeve. This patent attempts to provide a lamp-base combination which is simple to manufacture and assemble, provides for a connection without any play, and which is self adjusting to compensate for the tolerances of the base core. The assembly is of cementless type. The lamp capsule consists of a single ended bulb having a pinched press seal at one end from which extend the current connection leads. The two-part base consists of a metallic base sleeve and a base core of an insulating material. The base sleeve is a hollow structure and the base core is a cylindrical solid structure having apertures for electrical connections and shaped to snugly fit into the sleeve. Rims and projecting tabs are provided to lock the base sleeve and base core together without play.

### OBJECTS OF THE INVENTION

The lamp assembly disclosed in U.S. Pat. No. 5,010,272 is still complicated and the presence of the adjustment sleeve causes manufacturing difficulties and makes the lamp uneconomical. Besides, the very nature of the assembly renders it difficult to ensure that the position of the filament with respect to the focus of the reflector is accurate for optimum performance.

Thus, there is a longfelt need for an improved lamp assembly, which is easy and economical to manufacture and simple to assemble and yet without any disadvantages of the prior art.

It is therefore, an object of the present invention to provide an improved lamp and socket assembly, which is economical to manufacture and simple to assemble.

It is another object of the present invention to provide a lamp assembly in which it is easily and economically possible to position the filament accurately with respect to the focus of the reflector of the headlights.

It is yet another object of the present invention to provide a lamp assembly the focus of, which is resistant to the shocks and other vibrations which the lamp may be subjected to during its normal usage.

Towards achieving some of these objects and overcoming the advantage of the prior art, the applicants own co-pending application No. 608/Del/99 discloses an improved incandescent lamp assembly, which comprises in combination, a single ended capsule having a press seal thereof. One or more filaments are located inside the capsule, and current connection leads extend from the press seal. A cylindrical cup portion with a slit on the top portion thereof for receiving the press seal portion of said capsule is provided. The socket means is closed at one end with an insulated material in which the said electrical connection leads are embedded, the open upper portion of the socket means receiving said cup in a snug yet adjustable manner. The socket has one or more vertical weld means for weldably connecting said socket means to said cup, and one or more horizontal weld means located between said vertical weld means. A pair of connection prongs extend outwardly and downwardly from said insulating material. There is also provided a hollow stepped ring with a stepped annular ring means and a flat collar means, the stepped ring means receiving in its hollow portion, the socket means in a sealed relationship. The said horizontal weld means is weldably sealed on the top surface said stepped annular ring.

In another co-pending application No. 110/Del/00 filed on Feb. 8, 2000, the applicants disclose yet another novel lamp and socket assembly. In this embodiment, the hollow ring means has flat portions for receiving the socket means in a sealed relationship. The hollow ring comprises a hollow stepped ring with a stepped annular ring means and a flat collar means, the stepped ring receiving in its hollow portion the socket means in a sealed relationship. In this embodiment, the horizontal weld means is weldably sealed on the top surface of said stepped annular ring.

The present invention on the other hand discloses yet another improved version of the lamp and socket assembly which is simpler in construction and easier to assemble as compared to the assemblies disclosed in the applicants co-pending applications referred to above. At the same time, the assembly of the present invention matches those disclosed in said co-pending applications in terms of performance.

As in said co-pending applications, in the present invention also, the lamp portion is the conventional capsule type bulb enclosing at least a filament having lead wires for electrical connections and a pinched flattened plate like portion on the other end having projections on both surfaces. However, unlike the co-pending applications, the present invention, is characterised by an adapter means with a stepped up portion to receive the pinched potion of the glass capsule. The adapter consists of flaps to lock on the projections of the flat surfaces of capsule. The adapter is mounted on an adjustment collar as will be explained hereinafter. The special construction of the socket, the adapter and the adjustment collar achieves the objects of the invention in a simple yet novel manner, rendering the lamp of the present invention highly economical and commercially viable.

Accordingly, the present invention provides an improved incandescent lamp assembly, which comprises in combination,
a single ended capsule having a press seal thereof, one or more filaments located inside the capsule, current connection leads extending from the press seal;
an adapter means with an elevated or stepped up portion having a slit through on said elevated or stepped up portion thereof for receiving the press seal portion of said capsule;
an adjustment collar having a flat surface and downwardly extending sidewalls, said adapter means being weldably mounted on said adjustment collar, said adjustment collar having an opening for receiving at least a part of said press seal portion and current connection leads,
a socket means closed at one end with an insulated material in which the said electrical connection leads are embedded, the open upper potion of the socket means receiving said adjustment collar in a snug yet adjustable manner; one or more weld means for weldably connecting said socket means to said adjustment collar and a pair of connection prongs extending outwardly and downwardly from said insulating material.

One of the advantages of the present invention is that it may conveniently be employed with different forms of socket assemblies as will be shown hereinafter.

### DETAILED DESCRIPTION OF THE INVENTION

The present invention will now be described with reference to the accompanying drawings in which like parts are identified by the same reference numerals, wherein:

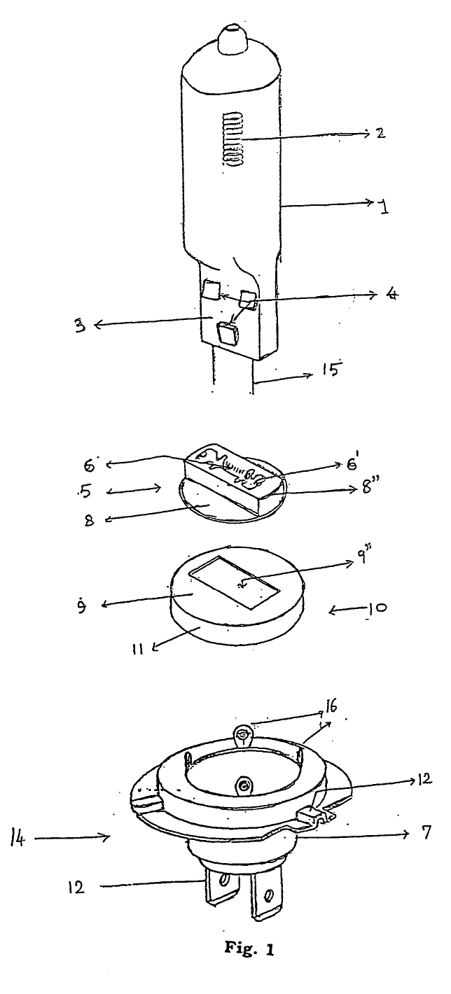

FIG. 1 is an exploded view of the lamp-socket assembly of the present invention depicting the novel adapter means and the novel annular collar;

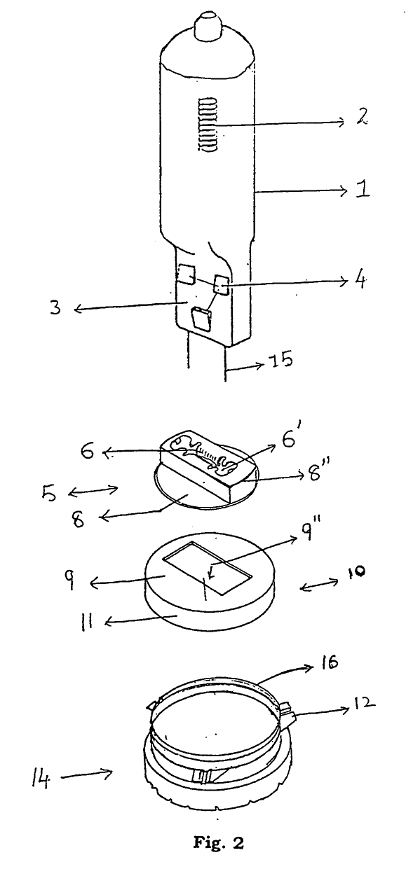

FIG. 2 is an exploded view of the lamp-socket assembly of the present invention depicting the novel adapter means and the novel annular collar with an alternative embodiment of the socket and weld lugs;

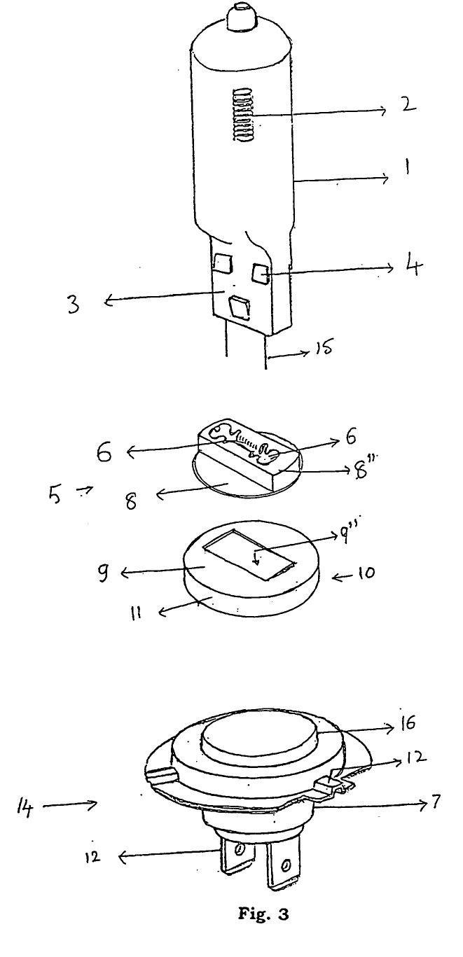

FIG. 3 is an exploded view of the lamp-socket assembly of the present invention depicting the novel adapter means and the novel annular collar with yet another alternative embodiment of the socket and weld lugs;

Referring to the Figures, a conventional lamp currently used comprises of a glass capsule 1 enclosing a filament 2. The glass capsule is filled an inert gas, usually along with a halogen additive. One end of the glass capsule has a pinched press seal portion 3 with an outwardly extending lug like projection 4 for enabling the capsule 1 to snap fit into an adapter means. The adapter means 5 may be metallic and consists of an elevated or stepped portion 8″ and flat horizontal portion 8. A slit 6′ passes through on the top of said stepped up portion 8″. The slit 6′ is so dimensioned that the press seal 4 of the capsule fits snugly in the slit 6′. Extending into the slit 6′ are crimps or flaps 6 which snap fit with and locks on to the projections 4 of the capsule.

The adapter means is weldably mounted on an adjustment collar 10. The adjustment collar has a flat surface 9 with an opening 9″ to accommodate the pinch portion 3 with current connecting leads 15, which extending through the slit 6′ of said adapter means in the assembled form. The adjustment collar also has cylindrical sidewalls 11 surrounding the opening 9″. The flat surface 8 of said adapter means weldably is mounted on the flat surface 9 of said adjustment collar. In the mounted form the slits 6′ of the adapter means and the opening 9″ of said adjustment collar have to be in perfect alignment with each other to enable the pinches portion 3 of the capsule to pass comfortably therethrough. Care is taken to ensure that the welding of the two flat surfaces 8 and 9 is carried out only after focussing. Focussing is achieved by sliding the glass capsule with the adapter means over the horizontal surface 9 of the adjustment collar so that the centre of at least one end of the filament falls on the central axis passing through the centre of the vertical sidewalls of the adjustment collar and perpendicular to the horizontal flat surface of the adjustment collar.

The socket 14 is a metallic cylinder embedded in an insulating material in which the electrical terminals are embedded. At least a pair of connecting prongs or pins project from the insulating material to electrically connect the filament 2 of the capsule. It is perfectly within the scope of the present invention to employ a socket as envisaged in the applicants' co-pending applications nos. 608/Del/99 and 110/Del/00, the entire contents of both of which are incorporated herein by virtue of reference.

The present invention also conveniently employs a glass capsule 1, preferably quartz glass or hard glass, which are resistant to high temperatures, enclosing at least one filament 2. While the particular embodiment of the present invention illustrated in the sole figure of the drawings disclose a single filament, it is within the scope of the present invention to include two filaments or multi filaments for ‘high’ beam and ‘low’ beam projections and the reference to filament may be construed accordingly.

The glass capsule 1 is filled with inert gas, which may have a halogen additive. The base portion of the capsule has a pinched press seal portion 3 having two flat surfaces. Each of the flat plate like surfaces has at least one outwardly extending projection 4 for snap fitting into a metallic adapter 5. A pair of connecting leads 15 connected to the filament project from the press seal portion of the capsule. The adapter 5 which is preferably metallic an elevated or stepped up portion 8″ with a slit 6′ on its top to receive the pinched press seal 3 of the capsule 1 in a snap fit manner. From the walls of the slit 6′ extend downwardly projecting flaps 6 which lock on to the projections 4 of the capsule to hold the capsule in a secure manner.

The lamp assembly of the present invention is characterised by novel adapter and the adjustment collar. In addition, it may also conveniently employ the novel socket and stepped ring, which offer unexpected advantages over the prior art as disclosed in the applicants' co-pending applications referred to above. The socket of the present invention is cylindrical in shape and is closed on one end with a plastic or other insulating material in which the electrical terminals are embedded. A pair of connecting prongs or pins 12 project from the insulating material to electrically connect the filament 2 of the capsule 1. The presence of the insulating material ensures that the heat generated by the bulb or the capsule is not transmitted thereto and thus any weakening or deformation thereof is avoided. In addition, the connecting pins 12, which project from the insulated material are automatically insulated from each other and from the headlight assembly. The upper open end of the socket has vertical weld means or lugs 16 for welding the socket assembly 7 to the adapter-adjustment collar assembly. In such an embodiment, the cylindrical side walls 11 of said adjustment collar will just fall inside the said welding lugs 16, the outer circumference of said cylindrical sidewalls 11 matching with the inner circumference defined by the set of said welding lugs 16. In an alternative embodiment, the welding lugs 16 may be dispensed with and the cylindrical sidewalls may be fitted inside the inner vertical walls of said socket. As shown in the FIG. 1, the vertical weld means comprise of four upwardly projecting lugs 16, which are concentric to the axis of the socket.

During assembling, the glass capsule or bulb 1 is fixed in the adapter means 5 by pushing the bulb mechanically into the slit 6′ of the adapter. The bulb snap fits into the slit 6′ with the holding flaps 6 locking against the projections 4 of the flattened end portion of the bulb.

Thereafter, the glass capsule 1 with the adapter 5 is placed on the top of the adjustment collar 10. The flat surface 8 of the adapter 5 matches with the flat surface 9 of the adjustment collar. The two surfaces are then welded together after focussing. As mentioned earlier, focussing is achieved by sliding the glass capsule with the adapter means over the horizontal surface 9 of the adjustment collar so that the centre of at least one end of the filament falls on the central axis passing through the centre of the vertical sidewalls of the adjustment collar and perpendicular to the horizontal flat surface of the adjustment collar.

After the welding of the surfaces 8 and 9, the adapter-adjustment collar assembly is placed in the socket with the vertical cylindrical sidewalls of the adjustment collar falling within the set of lugs 16 of the socket as shown in FIG. 1. Alternatively as shown in FIG. 2, the adapter-adjustment collar assembly is placed in the socket with the vertical cylindrical sidewalls of the adjustment collar falling within inside the vertical walls of the socket. In such embodiment, the outer circumference of the vertical cylindrical sidewalls of the adjustment collar will be equal to the inner diameter of vertical walls of the socket. In another embodiment shown in FIG. 3, the inner circumference of the vertical cylindrical sidewalls of the adjustment collar will be equal to the outer diameter of vertical walls of the socket. In this embodiment, the vertical cylindrical sidewalls of the adjustment collar surrounds vertical walls of the socket.

The assembly of the capsule with the adapter and the adjustment collar is moved along and around the vertical central axis of the adjustment collar and also around the two axes perpendicular to each other and in a horizontal plane, i.e., a plane perpendicular to the central axis of the adjustment collar. By doing this the filament is brought at a required distance from the reference plane defined by the flattened projections of the socket and the filament is made to fall on the reference axis of the metallic socket. Once such a situation is attained, the vertical walls of the adjustment collar are welded to the vertical lugs or at the vertical walls of the socket. Preferably, welding is laser welding since the use of laser ensures that after welding, the position of the capsule is not altered at all since no destabilising forces are applied or developed during laser welding.

In the assembly of the present invention, it is possible to adjust the position of the filament by moving the constituent parts along and around three axes perpendicular to each other i.e., along and around vertical axes and along and around two axes perpendicular to each other in horizontal plane.

Thus, the present invention makes it possible to position the filament with respect to the reference plane and reference axis by the adjustable movement of the sub assemblies before finally being welded with the filament at the position of optimum focus satisfying international standards.

It must be borne in mind the present invention has been illustrated above with reference to the most preferred embodiment and other modifications and embodiments of the invention are possible without departing from the spirit and scope of the invention.

1. An improved incandescent lamp which comprises in combination, a single ended capsule having a press seal thereof, one or more filaments located inside the capsule, current connection leads extending from the press SEAL; an adapter means with an elevated or stepped up portion having a slit through said elevated or stepped up portion thereof for receiving the press seal portion of said capsule; an adjustment collar having a flat surface and downwardly extending sidewalls, said adapter means being weldably mounted on said adjustment collar, said adjustment collar having an opening for receiving at least a part of said press seal portion and current connection leads, a socket means closed at one end with an insulated material in which the said electrical connection leads are embedded, the open upper potion of the socket means receiving said adjustment collar in a snug yet adjustable manner; one or more weld means for weldably connecting said socket means to said adjustment collar and a pair of connection prongs extending outwardly and downwardly from said insulating material.

2. A lamp assembly as claimed in claim 1 wherein said press seal means has two flat surfaces with at least a locking projection extending outwardly from each flat surface and said elevated portion of said adapter means having has locking flap means extending downwardly into the slit thereof so that when the capsule is pushed into said adapter means, the locking projections lock with said locking flaps so that the capsule is held by the adapter means without any play.

3. A lamp assembly as claimed in claim 1 wherein said vertical weld means comprises of a plurality of upwardly projecting lugs, said lugs being welded to said adjustable collar after said adjustable collar is positioned inside said socket means at a position of optimum focus.

4. A lamp assembly as claimed in claim 1 wherein said vertical weld means comprise the inner vertical walls of the socket, said vertical walls being weld connected to said adjustable collar.

5. A lamp assembly as claimed in claim 1 wherein said vertical weld means comprise the outer vertical walls of the socket, said vertical walls being weld connected to said adjustable collar.

6. A lamp assembly as claimed in claim 1 wherein said adapter means has a flat surface below said elevated portion and said adjustable collar has a flat surface surrounding said opening, said adapter means and said adjustable collar being weld connected to each other by means of their respective flat surfaces.
